(19) United States
(12) Patent Application Publication
(10) Pub. No.: US 2014/0375929 A1
(43) Pub. Date: Dec. 25, 2014

(54) LIGHT MANAGEMENT FILM

(71) Applicant: 3M INNOVATIVE PROPERTIES COMPANY, Saint Paul, MN (US)

(72) Inventors: Gary T. Boyd, Woodbury, MN (US); Qingbing Wang, Woodbury, MN (US); Kenneth Andrew Penner Meyer, White Bear Township, MN (US)

(21) Appl. No.: 14/369,031

(22) PCT Filed: Dec. 18, 2012
(86) PCT No.: PCT/US2012/070359

§ 371 Date: Jun. 26, 2014

Related U.S. Application Data
(60) Provisional application No. 61/580,371, filed on Dec. 27, 2011.

(51) Int. Cl. F21V 8/00; G02B 5/30

(52) U.S. Cl. CPC G02B 6/005; G02B 5/3025; G02B 6/0056
USPC 349/65; 359/485.01; 362/606; 362/607

(57) ABSTRACT

Example light management films including a plurality of tapered protrusions are described. In many embodiments, a film includes a reflective polarizer layer and a plurality of tapered protrusions disposed on and tapering away from the reflective polarizer layer. At least one tapered protrusion in the plurality of tapered protrusions has a first lateral cross-section at a first location along a height of the tapered protrusion and a second lateral cross-section at a second location along the height of the tapered protrusion. The first cross-section has a first shape and the second cross-section has a different second shape.

### FIELD

The disclosure relates to display devices and, in particular, films that may be used in backlit display devices.

### BACKGROUND

Optical displays, such as liquid crystal displays (LCDs), are becoming increasingly commonplace, and may be used, for example, in mobile telephones, portable computer devices ranging from hand held personal digital assistants (PDAs) to laptop computers, portable digital music players,

LCD desktop computer monitors, and LCD televisions. In addition to becoming more prevalent, LCDs are becoming thinner as the manufacturers of electronic devices incorporating LCDs strive for smaller package sizes. Many LCDs use a backlight for illuminating the LCD's display area.

### BRIEF SUMMARY

The present disclosure relates to light management films, among other aspects. In many embodiments a film is described. The film includes a reflective polarizer layer and a plurality of tapered protrusions disposed on and tapering away from the reflective polarizer layer. At least one tapered protrusion in the plurality of tapered protrusions has a first lateral cross-section at a first location along a height of the tapered protrusion and a second lateral cross-section at a second location along the height of the tapered protrusion. The first cross-section has a first shape and the second cross-section has a different second shape.

In some embodiments a display assembly is described. The display assembly includes a light source, a lightguide, an outer display surface, and a plurality of tapered protrusions between the lightguide and outer display surface and tapering toward the lightguide. At least selected tapered protrusions have a first lateral cross-section at a first location along a height of the tapered protrusion and a second lateral cross-section at a second location along the height of the tapered protrusion. The first cross-section has a first shape and the second cross-section has a different second shape.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIGS. 1A and 1B are schematic diagrams of an illustrative backlit display assembly;

FIG. 2 is a schematic diagram of an illustrative light management film;

FIG. 3 is a schematic diagram of an illustrative light management film and lightguide;

FIGS. 4 and 5 are schematic diagrams of illustrative light management films;

FIG. 6 is a schematic diagram of an illustrative plurality of tapered protrusions;

FIG. 7 is a schematic diagram of an illustrative tapered protrusion;

FIGS. 8A and 8B are cross-sectional views taken along lines 8A and 8B respectively of FIG. 7; and

FIG. 9 is an image showing an example array of conical shaped protrusions from a plan view.

The schematic drawings presented herein are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Any direction referred to herein, such as “top,” “bottom,” “left,” “right,” “upper,” “lower,” “above,” “below,” and other directions and orientations are described herein for clarity in reference to the figures and are not to be limiting of an actual device or system or use of the device or system. Many of the devices, articles or systems described herein may be used in a number of directions and orientations. The present disclosure describes light management film, among other aspects. In particular, the present disclosure relates to light management film that can be used to redirect light, for example, in a backlit display device. The film can include a plurality tapered protrusions defining a surface of the film. At least selected tapered protrusions have a first lateral cross-section at a first location along a height of the tapered protrusion and a second lateral cross-section at a second location along the height of the tapered protrusion. The first cross-section has a first shape and the second cross-section has a different second shape. In some examples, the film may include a reflective polarizer layer, in which case the plurality of protrusions may taper away from the reflective polarizer layer. When employed in a backlit display device, the film may be disposed between the light guide and display surface, and the plurality of protrusions may taper toward the light guide of the display and away from the display surface. In such an example, the plurality of tapered protrusions may be configured to reduce divergence of light incident upon surfaces of respective protrusions in at least one direction (e.g., two mutually orthogonal directions). Additionally, the plurality of tapered protrusions may be configured to redirect incident light such that for incident light propagating along a first direction, the protrusions redirects the majority of incident light along a second direction different than the first direction. While the present disclosure is not so limited, an appreciation of various aspects of the disclosure will be gained through a discussion of the examples provided below.

In some embodiments, a display device includes a rear reflector layer separated from the stack of light management films by the lightguide. The combination of the stack of light management films, lightguide, and reflective layers may be referred to as a backlight stack. For instances in which the layers of the backlight stack are oriented substantially parallel to the display surface of the LCD (liquid crystal display) and the light source is adjacent to one or more edges, the backlight stack may include the rear reflector, lightguide, a BD (bottom diffuser), two prism films, RP (reflective polarizer), and CS (cover sheet or diffuser) going in that order from back to front. The prism films can consist of a clear substrate topped with a plurality of parallel linear prisms with 90 degree apex angles. The prisms of the rear most prism film may be oriented to generally run in a direction orthogonal to those of the front prism film. In such cases, the prism films can be described as being in a crossed orientation, and may be configured to redirect some of the light from the lightguide toward the LCD. A short hand notation for the backlight stack is CS/RP/prism film/prism film/BD/lightguide/reflector, where the order is from the front of the backlight to the rear of the backlight. It may sometimes be desirable for the front and rear prism films to be oriented at an angle different than 90 degrees with respect to one another.

The light source and backlight stack of the display device can be configured to provide spatially and angularly uniform light illuminating the LCD with a relatively high level of efficiency. However, there continues to be a need to reduce the thickness of the backlight to make ever thinner backlit displays device, as well as reduce the materials and overall cost for constructing a backlight stack, while still maintaining a desirable level of performance. In some examples, the construction of a backlight stack and backlit display device may be complicated by the precision required when aligning the linear prism films relative to one another in a crossed orientation, and well as relative to the light source, lightguide and other components of the display device.

In some embodiments, a light management film includes a plurality of tapered protrusions where the cross-sectional shape of at least selected tapered protrusions changes along the height of the tapered protrusion. The plurality of tapered protrusions can include substantially polygonal base portions and a closed curve perimeter at a height along and spaced apart from the base portion. Such a film may be employed in a backlit display device between a lightguide and LCD. When incorporated into a backlit display device, the tapered protrusions may taper toward the lightguide and away from the LCD. For light passing through the light management film toward the LCD, the tapered protrusions may reduce the divergence of incident light and redirect a majority of incident light propagating along a first direction to a second direction different from the first direction.

In some embodiments, the light management film includes a plurality of tapered protrusions and a reflective polarizer layer. The tapered protrusions described herein of the redirecting layer may be disposed on (directly or indirectly) and taper away from the reflective polarizer layer. When employed in a backlit display device, the reflective polarizer layer may be separated from the lightguide by the plurality of tapered protrusions. In some examples, the light management film may include one or more other layers, such as, e.g., matte layers, clear layers, and/or adhesive layers in addition to that of the redirecting layer and reflective polarizer layer. In some examples, a light management film in accordance with some examples of the disclosure may allow for a single optical construction that may be placed between the surface of a lightguide and LCD in a backlit display device, e.g., as compared to the CS/RP/prism film/prism film/BD/lightguide/reflector configuration described above. In this manner, the overall thickness of a backlight stack for a backlit display device may be reduced as well as allow for a reduction in materials and overall cost for constructing a backlight stack.

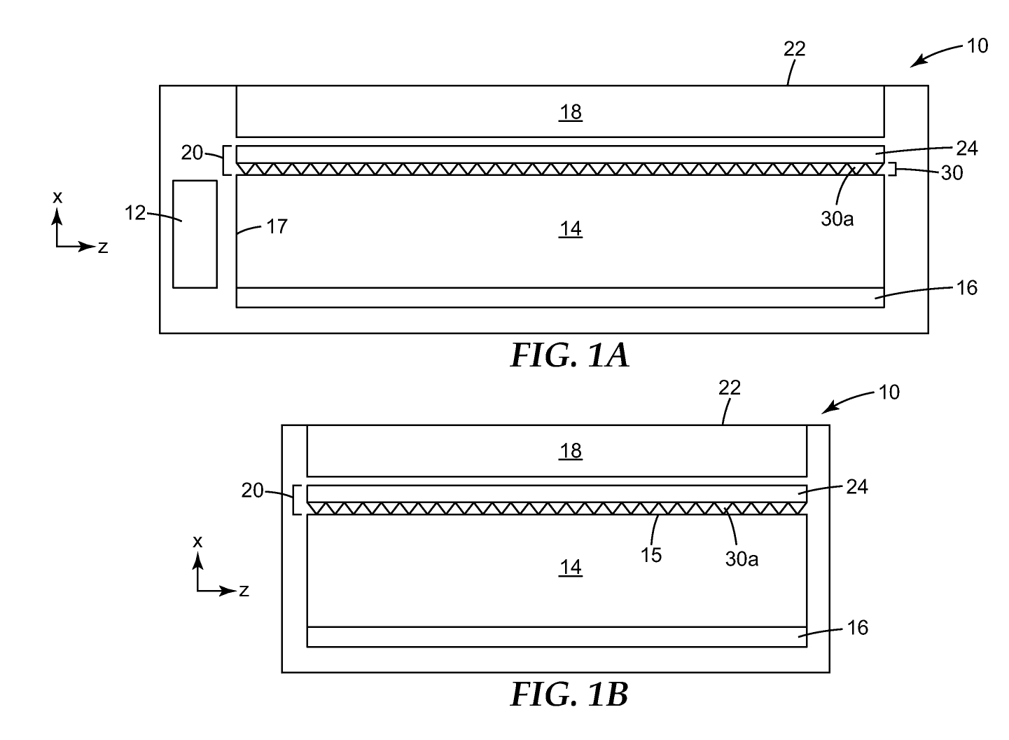

FIGS. 1A and 1B are conceptual diagrams illustrating example backlit display device 10. Backlit display device 10 includes light source 12, lightguide 14, reflector 16, LCD 18, and light management film 20. As shown, light management film 20 includes reflective polarizer layer 24 and plurality of tapered protrusions 30. For ease of illustration, only a single protrusion 30A is labeled in FIGS. 1A and 1B. However, throughout the disclosure, the individuals protrusions, such as, single protrusions 30A, may be collectively referred to as “plurality of tapered protrusions 30.” Although backlit display device 10 is illustrated with a single light source 12 adjacent to one edge 17 of lightguide 14, other configurations are contemplated. For example, backlit display device 10 may include more than one light source 12 adjacent to one or more surfaces of lightguide 14.

Light source 12 may be any suitable type of light source such as a fluorescent lamp or a light emitting diode (LED). Furthermore, light source 12 may include a plurality of discrete light sources such as a plurality of discrete LEDs. To illuminate the outer display surface 22 of LCD 18, light from light source 12 propagates through lightguide 14 in the general z-direction. At least a portion of the light exits through upper surface 15 of light guide 14 into light management film 20. Reflector 16 is located below lightguide 14, and reflects light back towards light management film 20.

A portion of the light entering light management film 20 from lightguide 14 may be redirected by plurality of tapered protrusions 30 before entering reflective polarizer layer 24. For example, some light may be refracted in the general direction (z-direction) of reflective polarizer layer 24 and LCD 18, while other portions of the light from lightguide 14 may pass through plurality of tapered protrusions 30 without being redirected. In some examples, the plurality of tapered protrusions 30 may redirect light incident with respect to the lightguide surface of protrusions 30 such that for incident light propagating along a first direction, the protrusions 30 redirect the majority of incident light along a second direction different than the first direction passing through plurality of tapered protrusions. The majority of incident light may refer to at least 50% of incident light with reference to light intensity. In some examples, the plurality of tapered protrusions 30 may redirect at least 60%, such as, at least 70%, at least 80%, at least 90%, or at least 95% of incident light in such a manner. However, other portions of light may be redirected by light management layer 20 back into lightguide 14. Some of this light may be “recycled” in the sense that the light may be reflected by reflector 16 back into lightguide 14 and light management layer 20.

Moreover, the plurality of tapered protrusions 30 may reduce divergence of light incident with respect to the lightguide surface in at least one direction, such as, two directions (e.g., two mutually orthogonal directions). Reducing the divergence of light in such a manner may refer to the reduction of divergence of greater than 50% of incident light, with regard to light intensity, such as, e.g., at least 60% at least 70%, at least 80%, at least 90%, or at least 95%, from lightguide 14.

In some examples, the extent that protrusions 30 redirect incident light depends on the incidence angle. For example, rays incident at polar angles (measured from the surface normal) less than 34 degrees are refracted to polar angles greater than 36 degrees (for refractive index of about 1.5 and apex angle of about 66.6 degrees of protrusions 30). In such cases, if may be preferable for a majority of light output to exhibit a polar angle range greater than approximately 34 degrees. In some examples, assembly 10 may be configured such that the majority of light incident to respective protrusions from the lightguide 14 exhibits an angle with respect to display normal that is greater than approximately 34 degrees. In some examples, lightguide 14 may be configured such that, with reference to light intensity, the at least 50%, such as, e.g., at least 60% at least 70%, at least 80%, at least 90%, or at least 95% of incident light from lightguide 14 exhibits an angle with respect to display normal (substantially orthogonal to surface 22 of display 18) that is greater than approximately 34 degrees, such as, e.g., greater than approximately 45 degrees or greater than approximately 60 degrees.

Of the light transmitted into reflective polarizer layer 24 from plurality of tapered protrusions 30, a portion may transmitted through reflective polarizer layer 24 into LCD 18, while light of a different polarization may be reflected back into lightguide 14 by reflective polarizer layer 24. In general, the polarization of the light reflected back into lightguide 14 by reflective polarizer layer 24 is such that the light would be absorbed by a rear polarizer of LCD 18. Instead, in some examples, this reflected light may be “recycled” in the sense that the light may be reflected by reflector 16 back into lightguide 14 and light management layer 20. The light passing through reflective polarizer layer 24 may be transmitted from light management film 20 into LCD 18 to illuminate outer display surface 22.

Lightguide 14 of backlit display device 10 may be any suitable lightguide known in the art and may include one or more of the example lightguides described in U.S. Pat. No. 6,002,829 to Winston et al. dated Dec. 14, 1999, and Pat. No. 7,833,621 to Jones et al. dated Nov. 16, 2010. The entire content of each of these U.S. are incorporated by reference herein. Suitable materials for reflector 16 adjacent to lightguide 14 may include Enhanced Specular Reflector (available commercially from 3M, St. Paul, Minn.), or a white PET-based reflector.

The material and construction of reflective polarizer layer 24 may be selected such that reflective polarizer layer 24 reflects light of a particular polarization state while transmitting light of another polarization state. For example, reflective polarizer layer 24 may have relatively low reflectivity for light polarization parallel to the pass axis of reflective polarizer layer 24 and relatively high reflectivity for light polarization perpendicular to the pass axis of reflective polarizer layer 24. As described above, reflective polarizer layer 24 may be selected to exhibit a relatively high reflectivity for light that would generally be absorbed by a rear polarizer of LCD 18, allowing that light instead to be reflected back into lightguide 14 and potentially recycled. Suitable materials for reflective polarizer layer 24 may include Dual Brightness Enhancement Film or “DBEF” (available commercially from 3M, St. Paul, MN). In some examples, reflective polarizer layer 24 may include multiple thin film layers having different optical properties.

As shown, plurality of tapered protrusions 30 are disposed on reflective polarizer layer 24 and positioned between reflective polarizer layer 24 and lightguide 14. Plurality of tapered protrusions 30 can include tapered protrusions having a first lateral cross-section at a first location along a height of the tapered protrusion and a second lateral cross-section at a second location along the height of the tapered protrusion, the first cross-section having a first shape and the second cross-section having a different second shape. Regardless of the shape, each protrusion of plurality of tapered protrusions 30 tapers toward lightguide 14, and tapers away from LCD 18 and reflective polarizer layer 24.

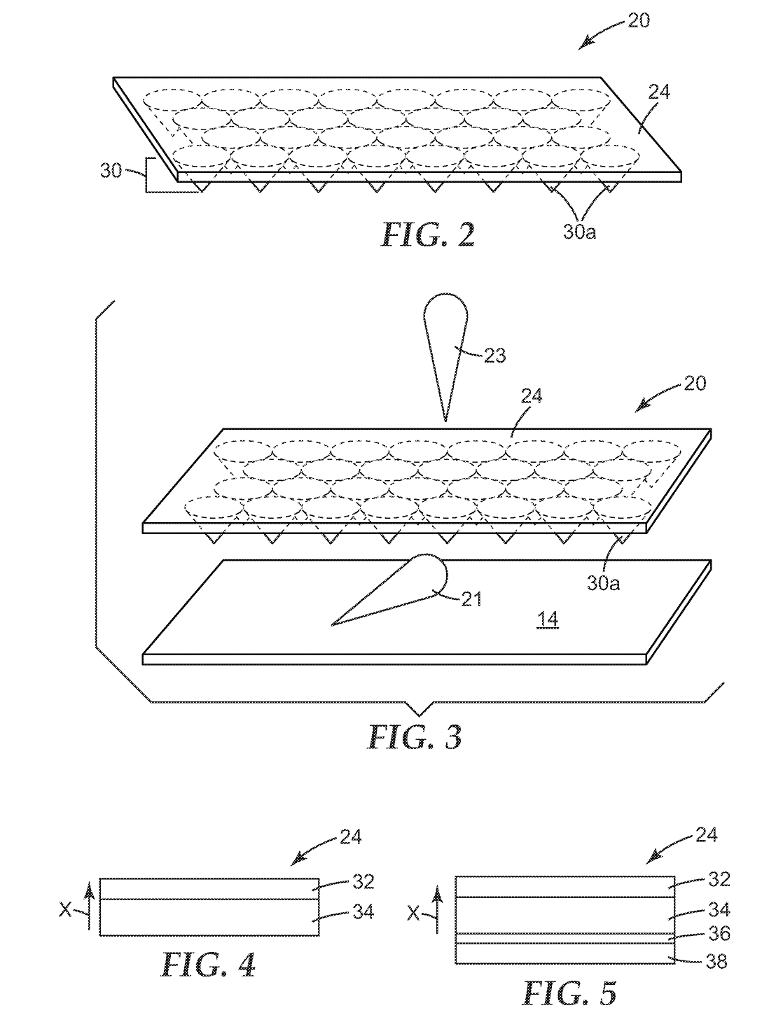

As shown by the combination of FIGS. 1A and 1B, the shape of plurality of protrusions 30 is such that each individual protrusion tapers toward lightguide 14 along two substantially orthogonal planes. For example, the sides of protrusion 30A taper toward each other in the direction of lightguide 14 for a cross section of protrusion 30A taken along the x-z plane as well as the x-y plane. Unlike that of linear prisms, each protrusion of plurality of protrusions 30 taper in this fashion in along substantially all planes substantially parallel to the x-axis, as oriented in FIGS 1A and 1B. While linear prisms may redirect/reroute light from lightguide 14, to redistribute at least a portion of the light toward LCD 18 within the x-z plane, plurality of protrusions 30 may redirect/reroute light from light guide 14, to redistribute at least a portion of the light toward LCD 18 within both the x-z and x-y planes. In some examples, plurality of tapered protrusions 30 may redirect light incident with respect to the lightguide surface of protrusions 30 such that for incident light propagating along a first direction, the protrusions redirects the majority of incident light along a second direction different than the first direction passing through plurality of tapered protrusions. Protrusions 30 may redirect/reroute at least a majority of such light from light guide 14 within both the x-z and x-y planes. Moreover, plurality of tapered protrusions 30 may reduce divergence of light incident with respect to the lightguide surface in at least one direction. FIG. 2 is a conceptual diagram illustrating example light management film 20 of FIGS. 1A and 1B. As shown, light management film 20 includes reflective polarizer layer 24 and plurality of tapered protrusions 30 disposed thereon. Plurality of tapered protrusions 30 are arranged in a single layer on the bottom surface of reflective polarizer layer 24. Plurality of tapered protrusions 30 extend out of the bottom surface of reflective polarizer layer 24 and taper away from layer 24. Plurality of protrusions 30 may have a substantially homogeneous construction, e.g., all protrusions are similarly sized and shaped, or the size and shape of the protrusions may vary substantially continuously or, alternatively, non-continuously.

Tapered protrusions 30 may be arranged in any suitable pattern. In the example shown in FIG. 2, plurality of tapered protrusions 30 are generally arranged in a series of rows and columns in substantially a hexagonal close packed (HCP) pattern. While the base of tapered protrusions (i.e., base portions) are shown as circular, in some examples, the base of protrusions 30 may have a hexagonal shape. Another example HCP structure is shown in FIG. 9. In other examples, plurality of tapered intrusions 30 may be arranged as a square grid pattern.

Gaps between the bases of adjacent tapered protrusions 30 may result in leakage through light management film 20, which can influence the performance of light management film 20. In general, the gaps between the bases of adjacent tapered protrusions may be flat, inactive areas that result in such leakage. As such, in some examples, tapered protrusions 30 may be arranged in a manner that reduces such gaps between adjacent tapered protrusions 30. In some examples, plurality of protrusions 30 may be arranged such that there are substantially no gaps between the bases of adjacent protrusions 30, e.g., as may be the case for an HCP arrangement in which protrusions 30 have a hexagonal base. In some examples, interfaces between the bases of neighboring protrusions may have substantial portions in contact with each other. In some examples, substantial portions may include to at least 50%, such as, e.g., at least 60% or at least 70% in contact with each other.

The areal density of tapered protrusions 30 disposed on reflective polarizer layer 24 may also influence the properties of light management film 20. In general, the density of tapered protrusions 30 relative the surface area of reflective polarizer layer 24 may be expressed in terms of the fraction of the surface area covered by protrusions 30. For protrusions with a hexagonal base in an ideal HCP arrangement, the fraction is approximately 100%, as is the case for protrusions with a square base in a square grid. For circular base protrusions, in a square array the fraction is approximately 78.5% (=π/4) and in a HCP arrangement the fraction is approximately 90.7% (=π/2√3).

Any suitable material may be used to form plurality of tapered protrusions 30. As described above, the shape and materials of plurality of tapered protrusions 30 may allow at least a portion of light from lightguide 14 passing through light management film 20 to reduce the divergence of incident light and redirect a majority of incident light propagating along a first direction to a second direction different from the first direction. Suitable materials may include optical polymers such as acrylates, polycarbonate, polystyrene, styrene acrylo nitrile, and the like. Suitable materials may include those materials used to form Brightness Enhancing Film or “BEF” (commercially available from 3M, St. Paul, Minn.). In some examples, the material used to form plurality of tapered protrusions 30 may have the refractive index between approximately 1.4 and approximately 1.7, such as, e.g., between approximately 1.45 and approximately 1.6. However, in some cases, the shape of protrusions 30 of light management film 20 may allow the properties of the light management film 20 to maintain a substantially constant out angle distribution over a wide range of the refractive index of the material used to form protrusions 30.

FIG. 3 is a conceptual diagram illustrating an exploded view of example light management film 20 and example lightguide 14. As described above with regard to FIGS. 1A and 1B, light 21 emitted from lightguide 14 into light management film 20 may be redirected and/or collimated to some extent when passing through light management film 20. In the example shown in FIG. 3, light 21 is redirected in a direction substantially orthogonal to the upper surface of light management film 20 as light 23. Light 23 may enter LCD 18 and illuminate outer display surface 22 (FIGS. 1A and 1B).

The shape of plurality of protrusions 30 may influence the redirection of light passing through light management film 20. As previously described, the shape of protrusions 30 as substantially polygonal base portions and a curved perimeter cross-section at a height above the base portion allows light management film 20 to redirect light incident with respect to the lightguide surface of protrusions 30 such that for incident light propagating along a first direction, protrusions 30 redirect the majority of incident light along a second direction different than the first direction passing through plurality of tapered protrusions. Additionally, protrusions 30 may reduce the divergence of incident light passing through light management film 20 from lightguide 14. In some examples, referring to the azimuthal direction about perpendicular to the base plane of protrusions 30, and a “polar” angle measured from the perpendicular, the redirection toward the normal may be fairly insensitive to the azimuthal angle of the light from the lightguide if protrusions 30 have a sufficient number of sides (such as, e.g., greater than 10), and the peak polar incident angle matches the protrusion apex angle that allows reflection toward the normal. The redirection of light from lightguide 14 may be accomplished with only a single layer of tapered protrusions 30 as compared to, e.g., an example in which two linear prism films are stacked in a crossed configuration redirect light from a lightguide.

FIGS. 4 and 5 are conceptual diagrams illustrating two different examples of reflective polarizer layer 24 of example light management film 20. In the example of FIG. 4, layer 24 includes two sub-layers. In particular, reflective polarizer layer 24 includes matte coating 32 on top of reflective polarizer sub-layer 34. Conversely, in the example of FIG. 5, reflective polarizer layer 24 includes matte coating 32, reflective polarizer sub-layer 34, adhesive sub-layer 36, and clear film sub-layer 38, in that order from top to bottom.

Suitable materials and construction of reflective polarizer sub-layer 34 may be substantially similar to that described above with regard to reflective polarizer layer 24 (FIGS. 1A and 1B). In general, reflective polarizer sub-layer 34 may reflect or transmit light from lightguide 14 and light management film 20 based on the polarization state of the light.

Matte coating 32 may act to reduce resolution of undesired visual artifacts for light transmitted through reflective polarizer sub-layer 34 due to, e.g., defects in lightguide 14 or bright regions near light source 12. In some examples, matte coating 32 may have a thickness between approximately 3 micrometers and approximately 100 micrometers and may be uniform or non-uniform in thickness over surface of reflective polarizer sub-layer 34. Matte coating 32 may diffuse light to hide defects or improve spatial uniformity, as stated above. It may also provide some degree of collimation of outgoing light, and some degree of gain in the axial direction via angle recycling. Polystyrene or glass beads of one index may be mixed with a clear binder of another index, such as an acrylates, to create such a bead coating, or these components may have the same index if the coating results in surface protrusions. Such a matte coating may also be micro-replicated from a mold, using heat or UV curable clear polymers.

In the example of FIG. 5, clear film sub-layer 38 is bonded to reflective polarizer sub-layer 34 via adhesive sub-layer 36. Clear film sub-layer 38 may provide additional stiffness to the full film assembly to reduce warp and curl in films, and may have a thickness between approximately 10 micrometers and approximately 200 micrometers. Suitable materials for clear film sub-layer 38 may include PET, acrylic, poly carbonate, and the like. Adhesive sub-layer 36 used to bond clear film 38 to reflective polarizer sub-layer 34 may be clear or diffusive. Example materials for adhesive sub-layer 36 may include optically clear pressure sensitive adhesive, acrylates, urethane acrylates or any optically clear adhesive material.

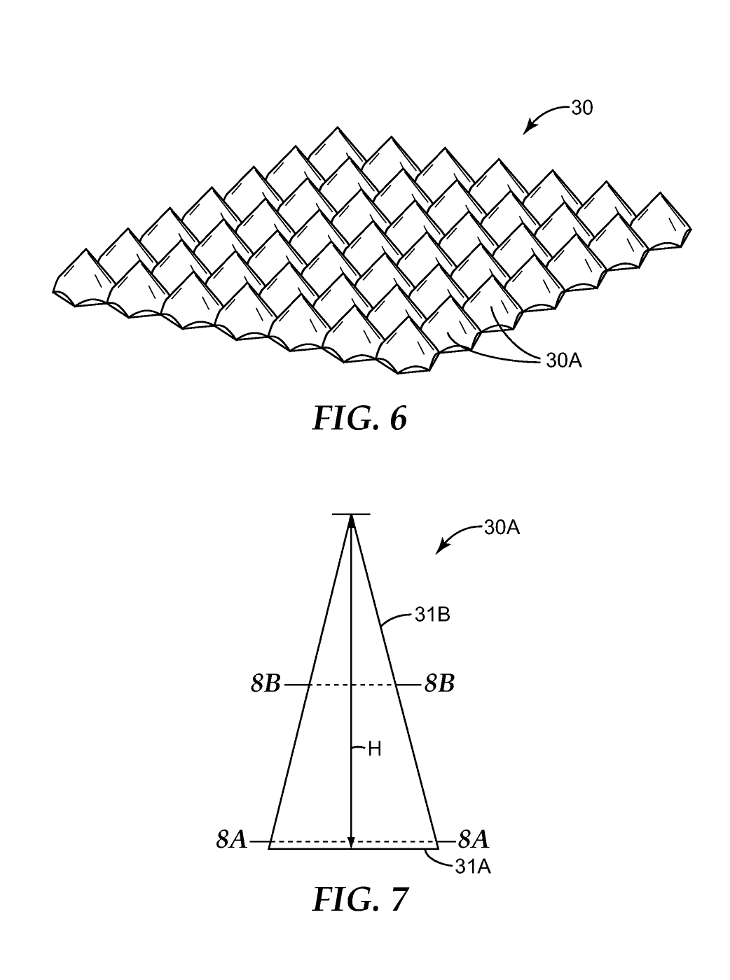

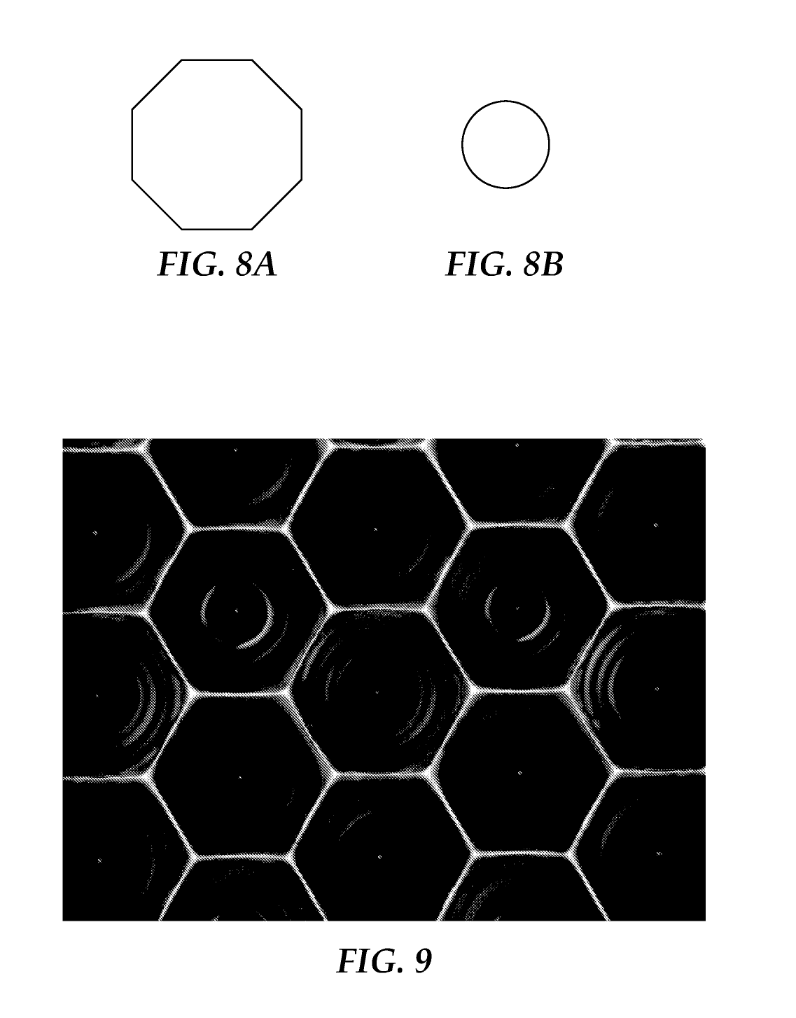

In the configuration shown in FIGS. 4 and 5, matte coating 32 may be positioned between reflective polarizer sub-layer 34 and LCD 18 (FIGS. 1A and 1B). Although not shown, plurality of protrusions 30 may be disposed on (directly or indirectly) the bottom surface of reflective polarizer layer 24. In some examples, reflective polarizer layer 24 may serve as a substrate for protrusions 30 to form plurality of protrusions 30. The configurations of reflective polarizer layer 24 in FIGS. 4 and 5 are merely exemplary, and other configurations are contemplated. In some examples, reflective polarizer layer 24 may not include matte coating 32 and/or clear film sub-layer 38. Additionally or alternatively, light management film 20 may include one or more diffusive layers, e.g., to reduce the resolution of undesired visual artifacts due to, e.g., lightguide defects or bright regions near light source 12. In some examples, a prism structure or an asymmetrically scattering diffuser structure may be substituted for the matte coating. All such structures may provide angle management of light above the reflective polarizer. FIG. 6 is a perspective view of an illustrative plurality of tapered protrusions 30. FIG. 7 is a schematic diagram of an illustrative tapered protrusion 30A. FIG. 8A and 8B are cross-sectional views taken along lines 8A and 8B respectively of FIG. 7.

The plurality of tapered protrusions 30 can be tightly packed as described above. To accomplish the tight packing the base portion 31A of the illustrative tapered protrusion 30A can have a polygonal shape or perimeter. At least one or selected or all tapered protrusions 30A in the plurality of tapered protrusions 30 have a first lateral cross-section (e.g., FIG. 8A) at a first location (e.g., base portion 31A) along a height H of the tapered protrusion 30A and a second lateral cross-section (e.g., FIG. 8B) at a second location (e.g., side portion 31B) along the height H of the tapered protrusion 30A. The first cross-section has a first shape and the second cross-section has a different second shape. In some embodiments the first lateral cross-section has a hexagonal perimeter or cross-sectional shape as illustrated in FIG. 8A and the second lateral cross-section has a curved, elliptical or circular shape as illustrated in FIG. 8B. In many embodiments, the second location is closer to the reflective polarizer layer and the first location is farther from the reflective polarizer layer.

In many embodiments at least one of the first and second shapes is a combination of straight lines and curves. In many embodiments the first shape has a piecewise linear perimeter and the second shape has a piecewise curved perimeter. In some embodiments, the first shape is a polygon and the second shape has a closed curve perimeter. In some of these embodiments, the polygon is a regular polygon and the closed curve perimeter is a circle or ellipse. In many embodiments, the first shape is a polygon with rounded corners and the second shape has a closed curve perimeter.

FIG. 9 is an image showing an example array of conical shaped protrusions from a plan view. As illustrated in FIG. 9, the tapered protrusions have base portions and neighboring protrusions base portions are in substantial contact with each other.

Any suitable technique may be utilized to fabricate examples of the disclosure. Example manufacturing techniques for fabricating a redirecting layer including a plurality of tapered protrusions (e.g., redirecting layer 26) include embossing, extrusion replication, UV cured molding, and compression molding. Molds for the replication process can be created by indention, laser ablation, lithography and chemical etching, or by diamond turning.

In some examples, tapered protrusion 30A terminates at substantially the same point to form a “sharp tip”. In other examples, tapered protrusion 30A does not have a sharp tip. In such case, the substantially tapered protrusion may be essentially a sharp tipped protrusion with a portion of the tip removed. While the example of FIG. 7 shows the top of tapered protrusion 30A with a sharp tip, other configurations are contemplated. For example, the top surface of tapered protrusion 30A in FIG. 7 may be non-planar, e.g., convex, and/or may be canted relative to the base surface. A convex tip surface may be referred as a “rounded” tip. Truncation or rounding of the tip may be beneficial to improve robustness of the film and to mitigate potential breakage of the tip portion during assembly and use of light management film 20, for example, in display device 10. For a fixed tip radius, it may also be beneficial to maximize the base radius (cone spacing) to minimize the effects of tip truncation or rounding.

In some examples, the tip of tapered protrusion 30A may be reasonably sharp to redirect the maximum amount of light toward the axial direction (x-direction in FIGS. 1A and 1B). For example, in some cases, the axial luminance of light management film 20 decreases with the relative area of the tip and base regions of protrusions 30. In the case of tapered protrusion 30A with a truncated tip, it may be preferred that the truncated tip area be less than about 20%, such as, e.g., less than about 10 percent of the base area to reduce light loss.

In some examples, narrowing the protrusion cross section across the lightguide (elongating down-guide) may have the benefit of narrowing and concentrating the angular range of light exiting the protrusion, which can help increase the axial luminance. In some examples, protrusions may have aspects ratios between approximately 0.5 and approximately 2.0, such as, e.g., between approximately 0.8 and approximately 1.2.

As shown in FIG. 7, protrusion 30A protrudes from the surface of reflective polarizer layer 24, and has a height H. The height H of protrusion 30A may be in the range of approximately 10 micrometers to approximately 200 micrometers (such as, e.g., between approximately 20 micrometers to approximately 180 micrometers, or about 75 micrometers to about 150 micrometers). In some examples, protrusion 30A may have a height of at least approximately 10 micrometers. The height of protrusion 30A may define the thickness in the x-direction. More generally, the thickness of light management layer 20 (shown in FIGS. 1A and 1B, for example), which includes plurality of protrusions 30 and reflective polarizer layer 24, may be between approximately 35 micrometers and approximately 500 micrometers, such as, e.g., between approximately 50 micrometers and approximately 200 micrometers.

In some examples, protrusion geometry may be defined by the height, base and aspect ratio (base lateral dimension to the height dimension), cone tilt, and apex angle. In some examples, protrusion 30A may define a tilt within +/− approximately 10 degrees, and the cone apex angle may be between approximately 50 to approximately 80 degrees. As noted above, in some examples, protrusion 30A may have a height between approximately 10 micrometers to approximately 200 micrometers, and an aspect ratio between approximately 0.5 to approximately 2.0.

Thus, embodiments of LIGHT MANAGEMENT FILM are disclosed. One skilled in the art will appreciate that the optical films and film articles described herein can be practiced with embodiments other than those disclosed. The disclosed embodiments are presented for purposes of illustration and not limitation.

Item 1. A film, comprising:
a reflective polarizer layer; and
a plurality of tapered protrusions disposed on and tapering away from the reflective polarizer layer, at least one tapered protrusion in the plurality of tapered protrusions having a first lateral cross-section at a first location along a height of the tapered protrusion and a second lateral cross-section at a second location along the height of the tapered protrusion, the first cross-section having a first shape and the second cross-section having a different second shape.

Item 2. The film of item 1, wherein each tapered protrusion in the plurality of tapered protrusions has a first lateral cross-section at a first location along the height of the tapered protrusion and a second lateral cross-section at a second location along the height of the tapered protrusion, the first cross-section having a first shape and the second cross-section having a different second shape.

Item 3. The film of item 1, wherein the first shape has a piecewise linear perimeter and the second shape has a piecewise curved perimeter.

Item 4. The film of item 1, wherein the first shape is a polygon and the second shape has a closed curve perimeter.

Item 5. The film of item 4, wherein the polygon is a regular polygon and the closed curve perimeter is a circle.

Item 6. The film of item 4, wherein the second location is closer to the reflective polarizer layer and the first location is farther from the reflective polarizer layer.

Item 7. The film of item 1, wherein each tapered protrusion has a hexagonal base.

Item 8. The film of item 1, wherein the at least one tapered protrusion has the first lateral cross-sectional shape along a first portion of the height of the tapered protrusion and the second lateral cross-sectional shape along a different second portion of the height of the tapered protrusion.

Item 9. The film of item 1, wherein at least one of the first and second shapes is a combination of straight lines and curves.

Item 10. The film of item 1, wherein the first shape is a polygon with rounded corners and the second shape has a closed curve perimeter.

Item 11. The film of item 1, wherein the tapered protrusions have base portions and neighboring protrusions base portions are in substantial contact with each other.

Item 12. A display assembly comprising:

a light source;
a lightguide;
an outer display surface; and
a plurality of tapered protrusions between the lightguide and outer display surface, and tapering toward the lightguide, wherein at least selected tapered protrusions have a first lateral cross-section at a first location along a height of the tapered protrusion and a second lateral cross-section-section at a second location along the height of the tapered protrusion, the first cross-section having a first shape and the second cross-section having a different second shape.

Item 13. The display assembly of item 12, wherein the first shape has a piecewise linear perimeter and the second shape has a piecewise curved perimeter.

Item 14. The display assembly of item 12, wherein the first shape is a polygon and the second shape has a closed curve perimeter.

Item 15. The display assembly of item 14, wherein the polygon is a regular polygon and the closed curve perimeter is a circle.

Item 16. The display assembly of item 12, further comprising a reflective polarizer layer between the plurality of tapered protrusions and the outer display surface.

Item 17. The display assembly of item 12, wherein each tapered protrusion has a hexagonal base.

Item 18. The display assembly of item 12, wherein at least one of the first and second shapes is a combination of straight lines and curves.

Item 19. The display assembly of item 12, wherein the first shape is a polygon with rounded corners and the second shape has a closed curve perimeter.

Item 20. The display assembly of item 16, wherein the plurality of tapered protrusions are disposed directly on a surface of the reflective polarizer layer.

Item 21. The display assembly of item 12, further comprising a liquid crystal display (LCD) defining the outer display surface.

1. A film, comprising:
a reflective polarizer layer; and
a plurality of tapered protrusions disposed on and tapering away from the reflective polarizer layer, at least one tapered protrusion in the plurality of tapered protrusions having a first lateral cross-section at a first location along a height of the tapered protrusion and a second lateral cross-section at a second location along the height of the tapered protrusion, the first cross-section having a first shape and the second cross-section having a different second shape.

2. The film of claim 1, wherein each tapered protrusion in the plurality of tapered protrusions has a first lateral cross-section at a first location along the height of the tapered protrusion and a second lateral cross-section at a second location along the height of the tapered protrusion, the first cross-section having a first shape and the second cross-section having a different second shape.

3. The film of claim 1, wherein the first shape has a piecewise linear perimeter and the second shape has a piecewise curved perimeter.

4. The film of claim 1, wherein the first shape is a polygon and the second shape has a closed curve perimeter.

5. The film of claim 4, wherein the polygon is a regular polygon and the closed curve perimeter is a circle.

6. The film of claim 4, wherein the second location is closer to the reflective polarizer layer and the first location is farther from the reflective polarizer layer.

7. The film of claim 1, wherein each tapered protrusion has a hexagonal base.

8. The film of claim 1, wherein the at least one tapered protrusion has the first lateral cross-sectional shape along a first portion of the height of the tapered protrusion and the second lateral cross-sectional shape along a different second portion of the height of the tapered protrusion.

9. The film of claim 1, wherein the first shape is a polygon with rounded corners and the second shape has a closed curve perimeter.

10. The film of claim 1, wherein the tapered protrusions have base portions and neighboring protrusions base portions are in substantial contact with each other.

11. A display assembly comprising:
a light source;
a lightguide;
an outer display surface; and
a plurality of tapered protrusions between the lightguide and outer display surface, and tapering toward the lightguide, wherein at least selected tapered protrusions have a first lateral cross-section at a first location along a height of the tapered protrusion and a second lateral cross-section at a second location along the height of the tapered protrusion, the first cross-section having a first shape and the second cross-section having a different second shape.

12. The display assembly of claim 11, wherein the first shape has a piecewise linear perimeter and the second shape has a piecewise curved perimeter.

13. The display assembly of claim 11, wherein the first shape is a polygon and the second shape has a closed curve perimeter.

14. The display assembly of claim 13, wherein the polygon is a regular polygon and the closed curve perimeter is a circle.

15. The display assembly of claim 11, further comprising a reflective polarizer layer between the plurality of tapered protrusions and the outer display surface.

16. The display assembly of claim 11, wherein each tapered protrusion has a hexagonal base.

17. The display assembly of claim 11, wherein at least one of the first and second shapes is a combination of straight lines and curves.

18. The display assembly of claim 11, wherein the first shape is a polygon with rounded corners and the second shape has a closed curve perimeter.

19. The display assembly of claim 15, wherein the plurality of tapered protrusions are disposed directly on a surface of the reflective polarizer layer.

20. The display assembly of claim 11, further comprising a liquid crystal display (LCD) defining the outer display surface.
